(19) United States
(12) Patent Application Publication
(10) Pub. No.: US 2003/0084728 A1
(43) Pub. Date: May 8, 2003

(54) Modular electrolytic sensor

(76) Inventor: Eric S. Boltz, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/289,158

(22) Filed: Nov. 6, 2002

Related U.S. Application Data
(60) Provisional application No. 60/333,256, filed on Nov. 6, 2001.

(51) Int. Cl. G01L 9/00

(52) U.S. Cl. 73/753

(57) ABSTRACT

A modular electrolytic sensor having the capability to be utilized with a variety of probe portions. A modular electrolytic sensor having a head assembly, a probe portion and a mounting member for removably attaching the probe portion to the head assembly.

### TECHNICAL FIELD

The present invention relates to electrolytic sensors for determining the concentration of a constituent of a fluid stream.

### BACKGROUND OF THE INVENTION

Electrolytic sensors utilizing a solid electrolyte for measuring the concentration of a specific fluid, for example oxygen, within a sample fluid are known. Sensors may be used to measure, for example, the amount of oxygen in a furnace or other combustion chamber. It is often desirable, if not necessary, to insure that there is sufficient oxygen present within a chamber for combustion to progress. In some environments, for example, a reducing atmosphere, it may be necessary to measure and maintain the oxygen concentration in the range of parts per billion. Sensors are also used to determine the presence and/or concentration of noxious gases in enclosed environments, for example, in an underground storage tank.

To ensure that a monitored sample fluid is representative of the fluid within the environment being monitored, sensors should be sufficiently elongated to avoid sampling stagnant fluid near the walls of the enclosure. Elongated probes having one or more sample fluid inlet 26 ports at the distal end of the probe have been used to ensure that a representative fluid sample is monitored.

To clean and regenerate a sensor it can be removed from its service environment, disassembled and cleaned. This is a time consuming, labor intensive, and costly procedure. Additionally, a back-up sensor must be available during the period the sensor is being cleaned or there will be periods where no fluid monitoring occurs.

Alternatively, methods for in-situ cleaning of contaminated surfaces of a sensor have been developed. In some environments, for example, in a combustion chamber, the sensor is subjected to a high temperature sample gas which has a low oxygen concentration. Thus, by supplying a burn-off gas to the surface of the sensor which has an oxygen concentration sufficient to support combustion, the residual film on the surface of the sensor can be ignited by the high temperature sample gas and/or sensor surfaces, and the residual film is burned off. While this burn-off procedure removes the residual film, it also requires filling the sensing area with an oxygen rich gas, and, following the burn-off procedure, the sensing area of the sensor is filled with the combustion gas produced during the burn-off procedure. Accurate monitoring of the sample gas cannot continue until the oxygen rich burn-off gas and the combustion gases produced during the burn-off procedure are removed from the sensing area.

There are a wide variety of environments in which oxygen sensors must perform and survive. This necessitates a number of common configurations that are optimized for specific applications. For example, environments with temperatures in excess of 2200 F require a non-metallic outer sheath, which, in turn, necessitates a different sealing method at the probe flange. Similarly, probes that are exposed to rapidly varying temperatures must utilize components that are less susceptible to thermal shock.

Traditionally, these optimized configurations have been achieved by designing an application-specific sensor from the “ground up.” For manufacturers, the utilization of several different designs leads to substantial stocks in order to meet customer demand and on-time delivery requirements. In addition, traditional oxygen sensor designs require special tools and training to assemble. This means that the manufacturer or a trained individual with special tools must perform any product refurbishment or repair.

### SUMMARY OF THE INVENTION

The present invention provides a modular electrolytic sensor having customer-replaceable components. For example, the modular approach of the present invention allows the same head assembly to be employed with any of a variety of probe portions and a variety of sensor elements included in such probe portions. The end-user may even change the probe portion or sensor elements therein using common, everyday tools. In addition, the sensors may be refurbished by the end-user simply by replacing the component needing repair or replacement (such as the internal sensor element).

### BRIEF DESCRIPTION OF THE DRAWINGS

While the specification concludes with the claims particularly pointing out and distinctly claiming the present invention, it is believed that the same will better be understood from the following description taken in conjunction with the accompanying drawings in which:

FIG. 1 is a schematic, cross-sectional view of a modular sensor according to one embodiment of the present invention;

FIG. 2 is a cross-sectional view of the outer sheath assembly employed in FIG. 1;

FIG. 3 is a cross-sectional view of a bushing used in the modular sensor assembly of FIG. 1;

FIG. 4 is an end view of the bushing of FIG. 3;

FIG. 5 is a cross-sectioned view of a central mounting member used in FIG. 1;

FIG. 6 is a side view of the central mounting member of FIG. 5;

FIG. 7 is a schematic view depicting manipulation of pins 54;

FIG. 8 is a schematic cross-sectional view of a modular sensor according to one embodiment of the present invention, wherein the internal sensor element and associated bushing in FIG. 1 have been replaced by an alternative sensor element and associated bushing;

FIG. 9 is a cross-sectional view of a modular sensor according to one embodiment of the present invention wherein the probe portion has been replaced by another design;

FIG. 10 is a schematic, cross-sectional view of the probe portion of the sensor assembly of FIG. 9.; and

FIG. 11 is a side view of the connecting member used in the sensor assembly of FIG. 9.

### DETAILED DESCRIPTION

The modular sensor of the present invention allows multiple sensor functionalities to be realized with a small set of common components and a few components specific to the desired functionality, minimizing inventory needs for manufacturers. It is designed such that the sensor can be adequately serviced and rebuilt by the customer, providing a lower lifetime cost over replacement or return-to-factory refurbishment. In addition, the various sensor functionalities can be achieved by replacing only a subset of the components. This allows customers to optimize a sensor for a particular process without having to purchase an entirely new sensor. This modular design allows all of the most common optimizations to be obtained using a common core set of components with only a few that are specific to the application. Since the design is modular, a minimal stock is required to meet demand and delivery requirements.

The modular design utilizes a simplified and modular parts scheme that allows the product to be assembled and disassembled with, for example, two adjustable wrenches and a flathead screwdriver. The simple nature of the design makes it possible for any minimally skilled user to repair or refurbish the product. The modular and simplified design also allows the user to modify the product so that it is optimized for a different environment than the one for which it was initially purchased. For example, if the user realizes that they now need the sensor to perform at temperatures in excess of 2200F, yet the current product they own has an alloy sheath that cannot survive at this temperature, they can simply replace the alloy sheath with a ceramic sheath. With traditional designs they would need to replace the entire product at a cost several times that of a sheath replacement.

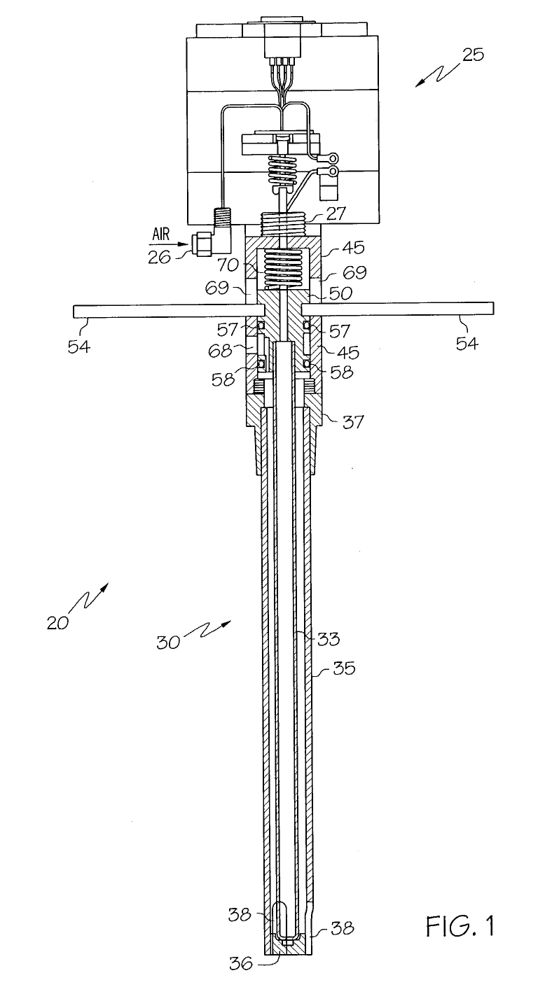

FIG. 1 is a schematic, cross-sectional view of a modular sensor 20 according to one embodiment of the present invention. Modular sensor 20 includes a head assembly 25 and a probe portion 30. In the modular sensor assembles of the present invention, head assembly 25 may have the same configuration for a variety of types of sensors. In this manner, the same head assembly 25 may be used for a variety of sensor types.

As noted in FIG. 1, head assembly 25 includes a reference air inlet through which reference air may pass and be directed into the interior of internal sensor element 33. Head assembly 25 is also configured to have a common terminal block arrangement to which electrical leads from the probe portion may be attached. A thermocouple load assembly is also provided in head assembly 25, as is known to those skilled in the art. In the embodiment shown, head assembly 25 has a 3-part design, however, this design is merely exemplary of one possible embodiment. In order to disassemble head assembly 25 from probe portion 30, head assembly 25 is merely opened using common, everyday tools, since the head assembly may be assembled using, for example, threaded fasteners which may be removed using a screwdriver. Once head assembly 25 has been opened, the electrical leads from the probe portion are merely disconnected from the terminal block.

As also seen in FIG. 1, the distal end of head assembly 25 includes a female threaded portion 27 which is configured to threadingly receive a male threaded portion of central mounting member 45, as further described herein. In this manner, after the electrical leads have been disconnected from the terminal block in the head assemble, head assembly 25 may be detached from probe portion 30 using, for example, adjustable wrenches and the like.

Probe portion 30 generally includes an internal sensor element 33, an outer sheath 35, a threaded cap 37 secured to the proximal end of outer sheath 35, a bushing 50 secured to the proximal end of internal sensor element 33, and a central mounting member 45 threadably attached to threaded cap 37 and configured to accommodate bushing 50 therein. In the embodiment of FIG. 1, internal sensor element 33 generally comprises a solid electrolyte, and is often referred to in the art as the “substrate.” Although not shown in FIG. 1, an internal electrode is located within the interior of internal sensor element 33, along with a thermocouple, and a ceramic tube which accommodates the wires of the thermocouple and internal electrodes. As is known to those skilled in the art, during operation, reference air is provided to the interior of internal sensor element 33 for purposes of measuring the concentration of an analyte (such as oxygen) in a sample fluid. At its proximal end, internal sensor element 33 is secured within a central bore of a bushing element 50, such as by means of cement or other suitable adhesive.

Modular sensor 20 of FIG. 1 also includes a conductive outer sheath 35 which acts as the second electrode of the sensor. A conductive tip structure 36 is located within the distal end of outer sheath 35, and is positioned so as to contact the distal end of internal sensor element 33 for purposes of electrical conduction. Tip structure 36 may have any of a variety of configurations designed to contact the distal end of internal sensor element 33. In particular, the tip structure described in my copending patent application titled Sensor, filed on even date herewith and incorporated herein by reference, may be employed. One or more apertures 38 are also provided at or adjacent to the distal end of outer sheath 35, as shown. Once again, apertures 38 may have any of a variety of number and configurations, and that shown is merely exemplary of one possible embodiment. In fact, one particular configuration for apertures 38 is described in my copending provisional patent application mentioned previously. Apertures 38 allow the sample fluid to pass therethrough for purposes of sensing the desired analyte.

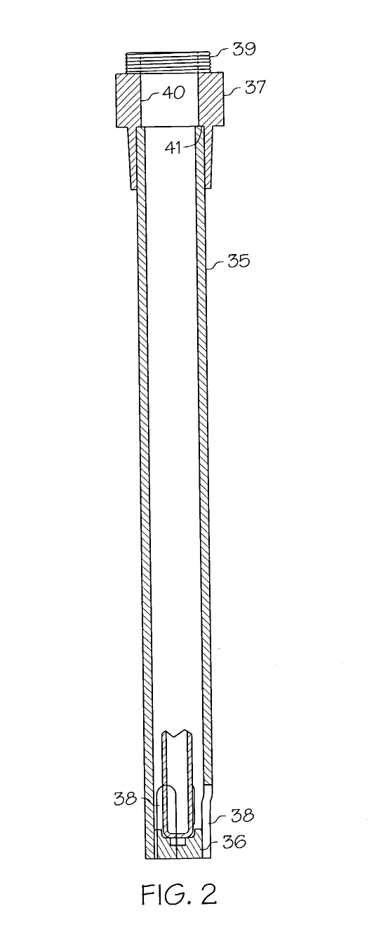

FIG. 2 is a schematic, cross sectional view of outer sheath 35. Since outer sheath 35 is conductive, in the embodiment of FIG. 1 it acts as the second electrode for the sensor. Typically, outer sheath 35 will be grounded via head assembly 25 in order to act as the second electrode. As also depicted in FIG. 2, the proximal end of outer sheath is welded (or otherwise affixed) within threaded cap 37, such as in a bore provided within the distal end of threaded cap 37. A shoulder 41 may also be provided at the upper end of this bore in order to assist in alignment and placement of threaded cap 37 on the proximal end of outer sheath 35. Threaded cap 37 also includes a central passageway 40 through which internal sensor element 33 may extend (as shown in FIG. 1). Threaded cap 37 also includes a threaded portion 39 configured such that threaded cap 37 (and hence outer sheath 35) may be threadably secured to central mounting member 45, as shown in FIG. 1.

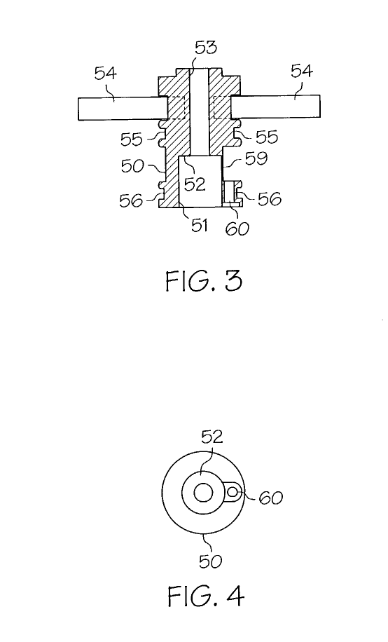

FIG. 3 is a cross-sectional view of bushing 50 employed in the modular sensor shown in FIG. 1. Bushing 50 includes a central bore 51 extending inwardly away from its distal end, as shown. A shoulder 52 is provided at the upper end of bore 51. Bore 51 is sized and configured to receive the proximal end of internal sensor element 33, as seen in FIG. 1. Bore 51 may, in fact, be sized and configured for a particular type of internal sensor element 33 such that the proximal end of the sensor element will be snuggly received in bore 51. In addition, cement or other type of adhesive may be used to secure the proximal end of internal sensor element 33 within bore 51. Although bore 51 may be tailored for any of a variety of specific internal sensor element types and structures, the external configuration of bushing 50 may be the same regardless of the type of internal sensor elements employed. In this manner, the same central mounting member 45 may be used for a variety of internal sensor element types.

Bushing 50 also includes an upper bore 53 which extends inwardly away from the proximal end of bushing 50 to lower bore 51. Bore 53 is sized and configured to accommodate, for example, a ceramic tube carrying wires from the interior of internal sensor element 33. Reference air is also provided to the interior of sensor element 33 via upper bore 53.

A pair of pins extend away from opposite sides of bushing 50, as seen in FIG. 3. Pins 54 may be secured to bushing 50 by any of a variety of means, such as by threads provided on the ends of pins 54 which are received in threaded bores of bushing 50. As further described below, pins 54 assist in the assembly of the modular sensor, and particularly prevent damage to the internal sensor element during assembly. Below pins 54, a pair of circumferential groves 55 and 56 extend around the outer circumference of bushing 50. Groves 55 and 56 are configured to receive O-rings 57 and 58, respectively, as seen in FIG. 1. In this manner, bushing 50 may be sealingly positioned within the interior central mounting member 45.

As also seen in FIG. 3, a cut-away portion 59 is provided in one side of bushing 50. Cut-away portion 59 is aligned with a passageway 60 which extends downwardly away from cut-away portion 59, as shown. Cut-away portion 59 and passageway 60 provide a fluid channel through which a burn-off gas may be supplied to the annular space between internal sensor element 33 and outer sheath 35. The purpose of the burn-off gas is further described in U.S. Pat. No. 5,851,369, which is incorporated herein by way of reference.

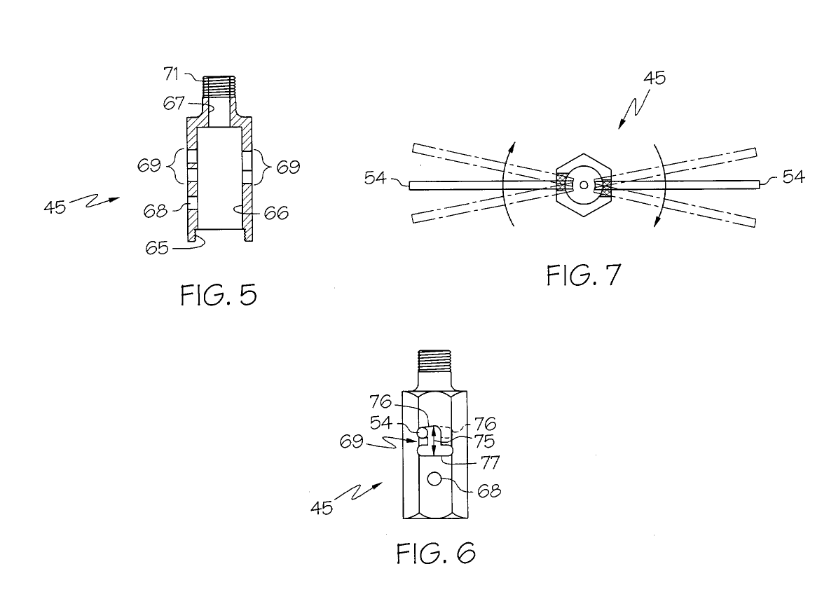

FIG. 5 is a cross-sectional view of central mounting member 45 of the modular sensor assembly of FIG. 1. As best seen in the side view of FIG. 6, the exterior surface of central mounting member 45 may be hexagonal in shape, or other suitable shape, in order to facilitate assembly of the modular sensor using adjustable wrenches and the like. At its lower or distal end, central mounting member 45 has a threaded recess 65 which is sized and configured to threadably receive threaded portion 39 of threaded cap 37. A cavity 36 is located immediately above threaded recess 65, and is sized and configured to receive bushing 50 therein. An upper bore 67 extends upwardly away from cavity 66 to the upper or proximal end of central mounting member 45. In this manner, the ceramic tube carrying wires and the like from internal sensor element 33 may pass through bore 67 into head assembly 25. An aperture 68 is provided on one side of central mounting member 45, and is located such that when bushing 50 is positioned within cavity 66, aperture 68 will be aligned with cut-away portion 59 of bushing 50. In this manner, burn-off gas may be supplied through aperture 68.

Slots 69 are provided on opposite sides of central mounting member 45, and extend into cavity 66. Slots 69 are located such that bushing 50 may be positioned within cavity 66, with pins 54 extending through slots 69, as shown in FIG. 1. It will be apparent that, during assembly, bushing 50 (with internal sensor element 33 secured thereto) must first be inserted into cavity 66 without pins 54 attached to bushing 50. Once bushing 50 is in place, pins 54 may then be inserted through slots 69 and secured to bushing 50 (such as by threading into threaded bores provided on bushing 50). Thereafter, threaded cap 37 (with outer sheath 35 attached thereto) is threadably attached to central mounting member 45 by threadably engaging threads 39 on cap 37 within threaded recess 65 of central mounting member 45. This completes the assembly of the probe portion of the modular sensor, and thereafter central mounting member 45 may be secured to head assembly 25, such as by threadably engaging threads 71 within threaded portion 27 of head assembly 25.

In order to insure adequate electrical contact between internal sensor element 33 and tip structure 36 of outer sheath 35, internal sensor element 33 may be spring biased against tip structure 36. As shown in FIG. 1, this may be accomplished by positioning a spring 70 within cavity 66 of central mounting member 45, immediately above bushing 50. In this manner, spring 70 will engage the upper end of cavity 66 and the upper end surface of bushing 50, thereby spring biasing bushing 50 and internal sensor element 33 downwardly toward tip structure 36. Although it is possible that pins 54 and corresponding slot 69 on central mounting member 45 may be omitted and threaded cap 37 merely threaded into threaded recess 65 of central mounting member 45 in order to complete the assembly of probe portion 30, assembling the modular sensor in this manner will cause the distal end of internal sensor element 33 to rub against tip structure 36 as the outer sheath is rotated. Such rubbing may damage the distal end of internal sensor element 33. Therefore, pins 54 are utilized to retract internal sensor element 33 away from tip structure 36 when the outer sheath assembly is being attached to central mounting member 45.

As seen in FIGS. 5 and 6, slots 69 provided on opposite sides of central mounting member 45 each have a longitudinally-extending portion 75. Since bushing 50 is spring biased downwardly towards tip structure 36, pins 54 will normally be located at or near the lowermost portion of slots 69. When pins 54 are in this position, internal sensing element 33 will be located at its lowermost position.

In order to attach the outer sheath assembly (comprising outer sheath 35 and threaded cap 37) to the central mounting member 45, it is desirable to retract internal sensor element 33 upwardly in order to prevent damage thereto. Therefore, pins 54 may be urged upwardly within slots 69 along longitudinally-extending portions 75. By doing so, spring 70 will be compressed and internal sensor element 33 will be retracted upwardly. The outer sheath assembly may then be threaded into the distal end of central mounting member 45 without risk of damage to the distal end of distal end of internal sensor element 33. Once the outer sheath assembly has been securely attached to central mounting member 45, the pins may be slowly and carefully released, thereby causing internal sensor element 33 to be spring biased downwardly until the distal end of sensor element 33 contacts tip structure 36 (as seen in FIG. 1).

In order to facilitate this assembly process, it may be desirable to provide a means for locking pins 54 in their upper (or retracted) position. Therefore, as seen in FIGS. 5 and 6, slots 69 each include a laterally-extending portion 76 which extends laterally away from longitudinally-extending portions 75, optionally at a slight downward angle. It should also be noted from FIG. 6 that laterally-extending portions 76 located on opposite sides of central mounting member 45 extend laterally away from their respective longitudinally-extending portions 75 in the same direction. Thus, for example, when central mounting member 45 is orientated as shown in FIGS. 6, laterally-extending portions 76 extend leftwardly away from longitudinally-extending portions 75. In this manner, after pins 54 are retracted upwardly within longitudinally-extending portions 75 of slots 69, pins 54 may be rotated with respect to central mounting member 45 into laterally-extending portions 76 of slot 69. As shown in FIG. 6, pins 54 will remain within laterally-extending portions 76 due to spring 70 urging bushing 50 (and hence pins 54) downwardly against the lower surface of laterally-extending portions 76 of slot 69. In this manner, pins 54, and hence bushing 50 and internal sensor element 33, may be locked into their retracted position in order to simplify the assembly process.

As also seen in FIG. 6, a second laterally-extending portion 77 may also be provided adjacent the lower end of longitudinally-extending portions 75 of each slot 69. In this manner, once the probe portion 30 has been assembled and pins 54 released to their downward position against or adjacent to the bottom edge of longitudinally-extending portions 75, pins 54 may be rotated in either direction into second laterally-extending portions 77 in order to prevent inadvertent retraction of internal sensor element 33.

One of the advantages of the modular sensor according to various embodiments of the present invention is that certain components are common to a variety of types of sensors which may be employed. For example, FIG. 8 is a schematic, cross-sectional view of a modular sensor assembly employing an alternative type of internal sensor element. In this embodiment, internal sensor element 133 is slightly narrower than internal sensor element 33 of FIG. 1 and has a slightly different tip arrangement. Nevertheless, it is not only important to insure that the tip of internal sensor element 133 makes adequate electrical contact with tip structure 36, but also that the tip of internal sensor 133 is not damaged during assembly. However, due to the modular configuration provided by the present invention, even though a different internal sensor element 133 is employed in FIG. 8, the outer sheath assembly (outer sheath 35 and threaded cap 37), central mounting member 45 and head assembly 25 are identical to that shown in FIG. 1. Modular sensor 120 in FIG. 8 does employ a modified bushing 150, as compared to bushing 50 in FIG. 1, however the only modification is the size and configuration of internal bore 151 of bushing 150. In particular, as noted in FIG. 8, bore 151 has a slightly smaller diameter (since internal sensor element 133 is slightly smaller), and has a modified length chosen to insure that the tip of sensor element 133 will be protected during assembly, and will make sufficient electrical contact with tip structure 36 after assembly.

Therefore, for example, if the end user is currently employing the modular sensor 20 of FIG. 1 and desires to change the type of internal sensor element 33, the end user merely rotatingly disengages threaded cap 37 from central mounting member 45, and rotatingly disengages central mounting member 45 from head assembly 25. A different sensor element (such as internal sensor element 133), together with the attached bushing (such as bushing 150) positioned within a new central mounting member 45, are then used to reassemble the sensor in the manner described previously. In this manner, the end user may replace the internal sensor element with a new sensor element of their choosing, or may replace any of the other modular components (such as head assembly 25 and/or the outer sheath structure).

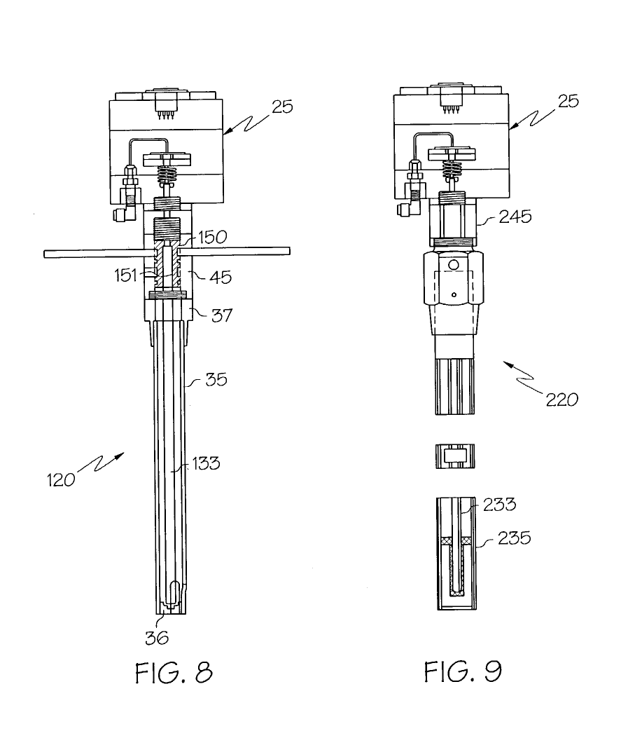

Some types of electrolyte sensors, such as oxygen sensors utilized in high temperature environments (e.g. 2200-3000 F) do not use a conductive outer sheath as the second electrode because of the high temperature environment. However, the modular sensor system of the present invention may nevertheless be used for such applications. FIG. 9 is a cross-sectional schematic view of one such sensor having an internal sensor element 233 and an outer, protective ceramic sheath 235. The second electrode may be provided, for example, by layers of painted platinum located within protective sheath 235. In addition, one or more apertures (not shown) are provided in outer sheath 235 for passage of a fluid sample therethrough. It should be pointed out that the internal configuration of sensor element 233 and the related electrodes are well-known to those skilled in the art.

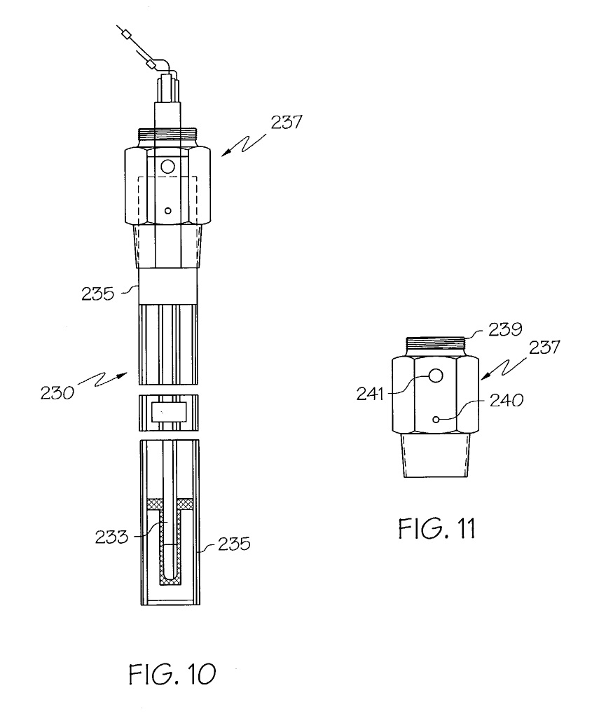

As best seen in FIGS. 10 and 11, the upper end of ceramic sheath 235 is secured to a connection member 237. By way of example, connection member 237 has a central bore into which the upper or proximal end of ceramic sheath 235 is inserted and cemented into place. An aperture 240 may be provided on connection member 237 such that cement (or other suitable adhesive) may be injected through aperture 240 in order to secure ceramic sheath 235 to connection member 237.

At its upper end, connection member 237 includes a threaded portion 239 which is configured for securing connection member 237, and hence probe portion 230, to a central mounting member 245 (see FIG. 9). As best seen in FIG. 9, central mounting member 245 includes a female threaded portion configured to receive threaded portion 239 of connection member 237 therein. At its proximal end, central mounting member 245 includes a threaded portion which is sized and configured to be threadingly received within threaded portion 27 of head assembly 25. Since head assembly 25 includes a common terminal block arrangement suitable for a variety of types of sensors, as well as a commonly-configured reference air supply arrangement, probe portion 230 of the high-temperature variety may be employed with the same head assembly 25 as the previous sensor embodiments. Therefore, the end user may once again modify the sensor system, as desired, in order to provide the most suitable sensor arrangement for the particular application. In the past, such modifications could generally not be made and therefore the end user would be required to either purchase an entirely new sensor assembly or return the sensor to the manufacturer for appropriate modifications.

What I claim is:

1. A modular electrolytic sensor comprising:
(a) head assembly having a proximal and distal end;
(b) probe portion; and
(c) mounting member for removably attaching the probe portion to the head assembly.

2. The modular electrolytic sensor of claim 1, wherein the probe portion comprises:
an internal sensor element having a proximal and distal end;
an outer sheath having a proximal and distal end;
a threading cap secured to the proximal end of the outer sheath; and
a bushing having a distal and proximal end, wherein the bushing is secured to the proximal end of the internal sensor element,
and further wherein the mounting member is threadingly attached to the threaded cap and wherein the mounting member is configured to accommodate the bushing therein.

3. The modular electrolytic sensor of claim 2, wherein the outer sheath comprises a conductive outer sheath.

4. The modular electrolytic sensor of claim 3, wherein the conductive outer sheath comprises a conductive tip structure located within the distal end of the outer sheath, and further wherein the conductive tip structure is positioned to be in electrical contact with the distal end of the internal sensor element.

5. The modular electrolytic sensor of claim 1, wherein the distal end of the head assembly comprises a female threaded portion, and wherein the mounting member comprises a male threaded portion, and further wherein the female threaded portion is configured to threadingly receive the male threaded portion of the mounting member.

6. The modular electrolytic sensor of claim 2, wherein the head assembly comprises a common terminal block, wherein the common terminal block is configured for electrical connection to the probe portion.

7. The modular electrolytic sensor of claim 2, wherein the outer sheath comprises a ceramic outer sheath.

8. The modular electrolytic sensor of claim 2, wherein the internal sensor element comprises:
a solid electrolyte;
an internal electrode;
a thermocouple; and
a ceramic tube configured to accommodate any wiring associated with the internal electrode and thermocouple.

9. The modular electrolytic sensor of claim 8, wherein the bushing comprises an upper bore and a lower bore, wherein the upper boar extends inwardly away from the proximal end of the bushing to the lower bore, and wherein the lower bore extends inwardly away from the distal end of the bushing.

10. The modular electrolytic sensor of claim 9, wherein the lower bore is sized and configured for the internal sensor element.
